(19) United States
(12) Patent Application Publication
(10) Pub. No.: US 2008/0024434 A1
(43) Pub. Date: Jan. 31, 2008

(54) Sound Information Output Device, Sound Information Output Method, and Sound Information Output Program

(76) Inventor: Fumio Isozaki, Tokyo (JP)

Correspondence Address: YOUNG & THOMPSON, 745 SOUTH 23RD STREET, 2ND FLOOR, ARLINGTON, VA, 22202, US

(21) Appl. No.: 11/547,365

(22) PCT Filed: Mar. 24, 2005
(86) PCT No.: PCT/JP05/05418

§ 371 Date: Dec. 14, 2006

(30) Foreign Application Priority Data
Mar. 30, 2004 (JP) 2004-101494

(51) Int. Cl. G09G 5/00

(52) U.S. Cl. 345/156

(57) ABSTRACT

A sound such that a pitch of the sound gradually rises and drops in accordance with increase and decrease in a set value with an operation by a user while, for example, an original sound and a location of the sound remain constant, is output. In this case, the user can figure out from an original sound and the location, just by listening to the sound, a value of which item is being set, and the user can also figure out from a pitch, how much value is being set. Each sound can more easily be heard by differentiating the location of the sound in a space for each set item, even when multiple sounds are output simultaneously.

### TECHNICAL FIELD

The present invention relates to a sound-data output device, a sound-data output method, and a sound-data output program that output sound data as a sound in accordance with an operation by a user. However, application of the present invention is not limited to the sound-data output device, the sound-data output method, and the sound-data output program.

### BACKGROUND ART

A technology generating a certain informing sound such as “blip” or “blop” with an operation by a user, such as a button pressing, is widely used regardless of types of device. With the feedback by sound, the user can recognize the fact that the user pressed the button just by listening, and in some cases, which button the user pressed. While the location of the informing sound is generally at the position of a speaker of a device, such a conventional technology is disclosed, for example, in the Patent document 1 below that localizes a sound image (not limited to the informing sound) at an arbitrary position in a space as if the sound image is output from a place different from the position of the speaker that actually outputs the sound image.

Patent document 1: Japanese Patent Laid-Open Publication No. H9-37397

### DISCLOSURE OF INVENTION

### Problem to be Solved by the Invention

However, with only the informing sound generated at the position of the speaker, it is hard to recognize what sound is generated since multiple sounds are mixed together when the user simultaneously conducts multiple operations or when some informing sound that is not based on an operation by the user is generated. With an input device such as a rotary encoder of which values can be continuously changed, the user in any case has to operate the device while checking what the current value is by looking at the device every time, since the informing sound in general is separately generated when the button is pressed, etc.

The conventional art has a problem that the operation of the user looking at the device every time can be a cause of carelessness or a traffic accident when the device is a vehicle-mounted device mounted on a vehicle, etc., and the user is driving. The safety problem is one example of the problems of the conventional art, and other problems include that the feedback by sound eventually requires the user to look at the device and that the user may feel the multiple sounds are rather noisy and the device is not a preferable user interface.

### Means for Solving Problem

A sound-data output device according to the invention of claim 1 outputs sound data as a sound in accordance with an operation by a user. The sound-data output device includes: a receiving unit that receives a set value input by the user; an identifying unit that identifies which set item the set value received by the receiving unit corresponds to; a determining unit that determines a parameter characterizing the sound based on at least one of the set value received by the receiving unit and the set item identified by the identifying unit; and an output unit that outputs a sound characterized by the parameter determined by the determining unit.

A sound-data output method according to the invention of claim 5 is a method of outputting sound data as a sound in accordance with an operation by a user. The sound-data output method includes: receiving a set value input by the user; identifying which set item the set value received at the receiving corresponds to; determining a parameter characterizing the sound based on at least one of the set value received at the receiving and the set item identified at the identifying; and outputting a sound characterized by the parameter determined at the determining.

A sound-data output program according to the invention of claim 6 is a program for outputting sound data as a sound in accordance with an operation by a user. The sound-data output program causes a computer to execute: receiving a set value input by the user; identifying which set item the set value received at the receiving corresponds to; determining a parameter characterizing the sound based on at least one of the set value received at the receiving and the set item identified at the identifying; and outputting a sound characterized by the parameter determined at the determining.

### BRIEF DESCRIPTION OF DRAWINGS

FIG. 1 is a block diagram of one example of a hardware configuration of a sound data output device according to a first embodiment of the present invention;

FIG. 2 is a block diagram of a functional configuration of the sound data output device according to the first embodiment of the present invention;

FIG. 3 is a flowchart of a procedure of a sound data output process associated with changes in values of various set items by the sound data output device according to the first embodiment of the present invention;

FIG. 4 is a block diagram of one example of a hardware configuration of a sound data output device according to a second embodiment of the present invention;

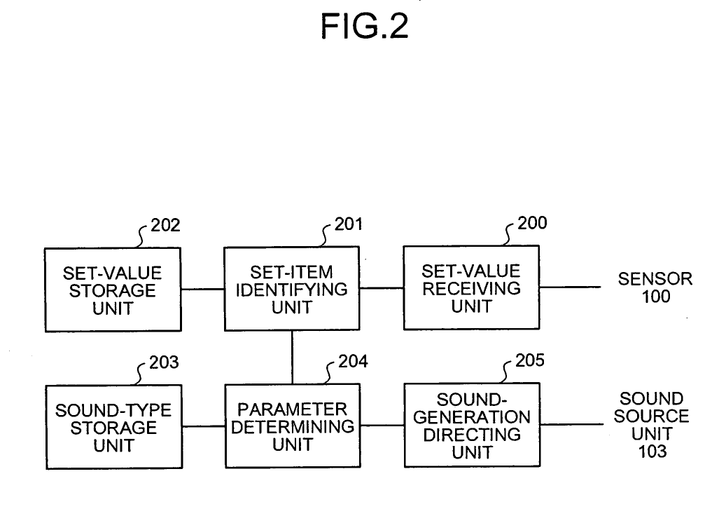

FIG. 2 is a block diagram of a functional configuration of the sound data output device according to the second embodiment of the present invention; and

FIG. 6 is a flowchart of a procedure of a sound data output process associated with changes and checks of values of various set items by the sound data output device according to the second embodiment of the present invention.

### EXPLANATIONS OF LETTERS OR NUMERALS

100 sensor

101, 401 processor

102, 402 memory

103, 403 sound source unit

104, 404 sound output unit

105, 405 speaker

400a set-value changing sensor

400b set-value checking sensor

200, 500 set-value receiving unit

201, 501 set-item identifying unit

202, 502 set-value storage unit

203, 503 sound-type storage unit

204, 504 parameter determining unit

205, 505 sound-generation directing unit

506 coordinate-value receiving unit

507 coordinate-value storage unit

508 check-item identifying unit

### BEST MODE(S) FOR CARRYING OUT THE INVENTION

Exemplary embodiments of a sound-data output device, a sound-data output method, and a sound-data output program according to the present invention will be explained in detail with reference to the accompanying drawings.

### First Embodiment

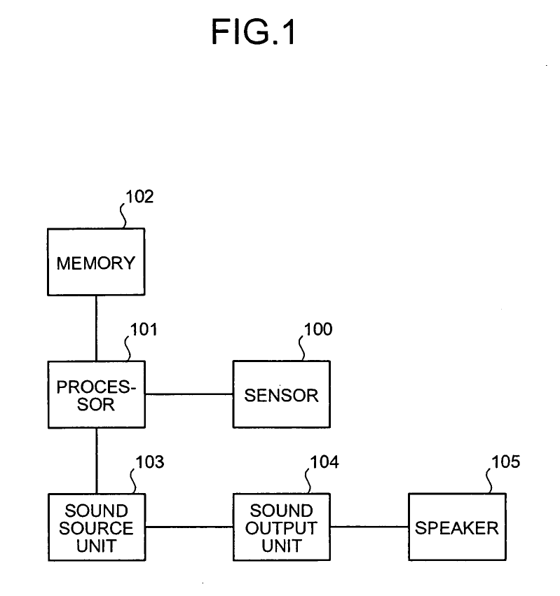

A hardware configuration of the sound-data output device according to the first embodiment of the present invention will be described. FIG. 1 is a block diagram of one example of the hardware configuration of the sound-data output device according to the first embodiment of the present invention. As shown in FIG. 1, a sensor 100 detects various operations by a user such as moving, pressing, touching, and holding, and outputs a signal corresponding to size, strength, acceleration, etc., of the operations to a processor 101 described below. The sensor 100 includes, for example, a rotary encoder and outputs signals corresponding to rotation amount and rotation speed whenever necessary.

However, the rotary encoder is only an example of the sensor 100, and other than the rotary encoder, the sensor 100 may include any of the devices that can convert continuous physical quantity given from outside into an electric signal that can be input into the device constantly. Examples of the devices include a wheel, a joystick, a track ball, a pressure sensor that can detect changes in pressing power of a finger and grasping power of a hand, and a motion sensor that can detect changes in positions of objects.

The processor 101 realizes determinations, output processes, etc., of various parameters described below by executing programs in a memory 102 described below. The memory 102 holds the programs executed by the processor 101, data used in the programs, etc.

A sound source unit 103 generates sounds specified by the parameters, based on the parameters input from the processor 101. Specifically, the sound source unit 103 includes an MIDI sound source chip. However, the MIDI sound source chip is only an example of the sound source unit 103, and any device that can generate an arbitrary tone can be used as a sound source unit 103.

A sound output unit 104 converts sound data input from the sound source unit 103 into an electric signal and outputs the signal to a speaker 105. The speaker 105 converts the electric signal input from the sound output unit 104 into a sound and outputs the sound.

A functional configuration of the sound-data output device according to the first embodiment of the present invention will then be explained. FIG. 2 is a block diagram of the functional configuration of the sound data-output device according to the first embodiment of the present invention. However, only essential parts of the various functions that the device provides, which are necessary to explain the present invention, are illustrated in FIG. 2.

A set-value receiving unit 200 shown in FIG. 2 is a functional unit that receives a signal (a set value) output by the sensor 100 shown in FIG. 1 in accordance with an operation by a user. Specifically, the set-value receiving unit 200 is realized by the processor 101 that executes programs in the memory 102 shown in FIG. 1.

A set-item identifying unit 201 is a functional unit that identifies which set items the set value received by the set-value receiving unit 200 corresponds to. Specifically, the set-item identifying unit 201 is realized by the processor 101 that executes programs in the memory 102 shown in FIG. 1. The “set item” varies depending on types and applications of the device. For example, set items are a room temperature, an amount of wind, etc., for a car air conditioner, and a volume of sound, degrees of various effects, etc., for a car audio. What the set items specifically are is not to be considered here, and the set items can be any item that defines an operation of a device and to which the user can set a value.

Although only one sensor is illustrated in FIG. 1 for convenience of the explanation, the plural sensors 100 may be actually present, such as one sensor setting a set item X and another sensor setting a set item Y. In some cases, one sensor 100 is used many times for multiple applications, such as the sensor 100 setting a set item X when an operation mode is A and setting a set item Y when an operation mode is B.

In the device, the set-item identifying unit 201 identifies which value of the set items a set value input from the sensor 100 corresponds to. In other words, the set-item identifying unit 201 identifies which value of the set items the user intends to change. Specifically, even if the plural sensors 100 are present, the set-item identifying unit 201 can identify the set item with a number assigned to each of interrupt lines, etc., when each sensor 100 is only used for a single application. When each sensor 100 is used for multiple applications, the set-item identifying unit 201 identifies the set item by referring to a current operation mode, etc., in addition to the number assigned to each of the interrupt lines.

A set-value storage unit 202 is a functional unit that holds current set value of each set item. Specifically, the set-value storage unit 202 is realized by the memory 102 shown in FIG. 1.

A sound-type storage unit 203 is a functional unit that holds “sound type” of the sound corresponding to each set item. Specifically, the sound-type storage unit 203 is realized by the memory 102 shown in FIG. 1.

The “sound type” is a concept that specifies “what the sound is like” including “behavior and manner” of the sound. The “sound type” defines the type of temporal and spatial changes of the parameters such as a sound volume, a pitch, a tone, a location, etc., which characterize the sound. For example, a sound type α, of which pitch gradually rises and drops in accordance with increase and decrease of the set value, is assigned to a set item X with the original sound and location remaining constant. A sound type β, of which location moves in the left and right directions in accordance with increase and decrease of the set value, is assigned to another set item Y. Correspondence of X with α and Y with β is then stored in the sound-type storage unit 203.

A parameter determining unit 204 is a functional unit that determines a value of a parameter of the sound to be currently generated by the sound source unit 103 shown in FIG. 1, based on the set value received by the set-value receiving unit 200, the set item identified by the set-item identifying unit 201, and the sound type of the set item being defined in the sound-type storage unit 203. Specifically, the parameter determining unit 204 is realized by the processor 101 that executes programs in the memory 102 shown in FIG. 1.

As described above, the sound source unit 103 specifically is an MIDI sound source chip and since multiple tones are preset as original sounds in the chip, just the original sound (or combination of multiple original sounds), a pitch bend, a panpot, a modulation, a timing of attack and release, etc., should be determined as parameters.

A sound-generation directing unit 205 is a functional unit that directs generation of a sound characterized by the parameters determined by the parameter determining unit 204, to the sound source unit 103 shown in FIG. 1. When the sound source unit 103 is an MIDI sound source chip as described above, the sound-generation directing unit 205 generates a predetermined MIDI message for each parameter and sequentially outputs the message to the sound source unit 103. Specifically, the sound-generation directing unit 205 is realized by the processor 101 that executes programs in the memory 102 shown FIG. 1.

### First Example

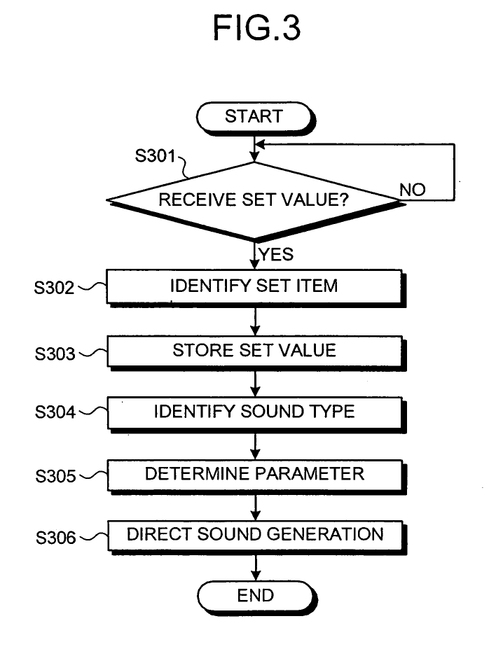

A first example of the sound-data output device according to the first embodiment of the present invention will be described. FIG. 3 is an explanatory view of the first example of the sound-data output device according to the first embodiment of the present invention. A flowchart of a procedure of a sound data-output process in accordance with changes of the values of various set items is shown in FIG. 3.

When the set-value receiving unit 200 realized by the processor 101 receives a set value in accordance with an operation by a user from the sensor 100 shown in FIG. 1 (step S301: YES), the set-item identifying unit 201 identifies which set item the set value corresponds to (step S302). The identified set item is searched in the set-value storage unit 202, and the current set value corresponding to the item is rewritten by the set value received at step 301, and the set value is stored (step S303).

The set-item identifying unit 201 then outputs a combination of the identified set item and set value to the parameter determining unit 204, and the parameter determining unit 204, receiving the combination, searches the sound-type storage unit 203 and identifies a sound type corresponding to the item (step S304). Values of various parameters characterizing the sound to be currently generated by the sound source unit 103 are determined, based on the sound type and the set value (step S305). The values are output to the sound-generation directing unit 205, and the sound-generation directing unit 205 directs sound generation by generating a message to cause the sound source unit 103 to generate the sound and by outputting the message to the sound source unit 103 (step S306).

According to the first embodiment described above, when the sensor 100 is operated and the set values are continuously changed, only the pitch changes while the original sound and location remains constant, or the location gradually moves, for example. Even when the same sensor 100 is operated in the same manner, since the set items vary depending on operation modes, the sound that can be heard with the operation and dimensions of the temporal and spatial changes of the sound also vary. Therefore, the user can figure out just by listening which values the user is specifically operating and what the current values are. Especially when the user is driving, inattentive driving can be prevented, and the safety of driving improves.

Even if multiple sounds are simultaneously output, since location of each sound can be differentiated, the user can more easily distinguish which sounds are generated, compared to the case the sounds from just one place can be heard.

Although, with a conventional MIDI-sound-source chip, sound location in the left and right directions can be designated with the panpot, a sound source capable of localizing the sound to an arbitrary position in the three-dimensional space can also be adopted as a sound source unit 103. In this case, the sound corresponding to the operation by the user can be arranged at any place and in any direction, back and forth, left and right, and up and down. For example, when the user changes a value of the set value X, corresponding sound can be heard from overhead to the right (fixed position) of the user as a driver, and when the user changes a value of the set value Y, corresponding sound approaches from the diagonally left up forward direction of the driver and passes through in the diagonally right down backward direction.

For example, when the location of sound is changed by a set value as in the set item Y, a meaning may be given to the distance from the sound, such as, by localizing the sound closer to the position of the user if the current set value is closer to the optimal value. In this case, the user can figure out whether the current set value is near the optimal value or can easily set the optimal value to the set item, with just the distance from the sound. Other than the location, for example, when the deviation from the optimal value is smaller, the volume of the sound may be set to be larger or the tone may be set to be clearer.

In the first embodiment, although a sound type is corresponded to each set item in advance, one sound type from the multiple sound types can be randomly selected to correspond to each set item upon the first change or check of the set value. The correspondence relationship is stored in the memory 102, and parameters of the sound (original sound, location, etc.) output in accordance with the first selected sound type are determined upon subsequent changes and checks of values of the set items.

Dynamically assigning the sound type of the corresponding sound in this manner also enables figuring out of the set value of the item by listening, when remotely operating an external device such as a portable MP3 player with hard disk like an iPOD (registered trademark) with the device and changing the value of an unknown (unplanned) set item, for example.

In other words, even a user who is driving can safely operate any device by using the device connected to the device. The external device can be connected to the device in any configuration (wired, wireless, infrared, etc.). During the remote operation, a displayed content (if exist) of a display of the external device is displayed on a display of the device, and if the external device to be operated is an iPOD (registered trademark), the content is displayed with a design identifiable as an iPOD (registered trademark).

### Second Embodiment

Although, in the first embodiment described above, degrees of the values and items can be figured out with behaviors of the sounds heard in accordance with operations, with the configuration described above, a user must listen to the sound that is near the current set values by operating the sensor 100 or has to check the states of the sensor 100 and displays of an indicator by looking, even when the user simply wants to check the current set values. The configuration can be such that the user can check the current set values just by listening, as in the second embodiment explained below, without changing or looking at the set values.

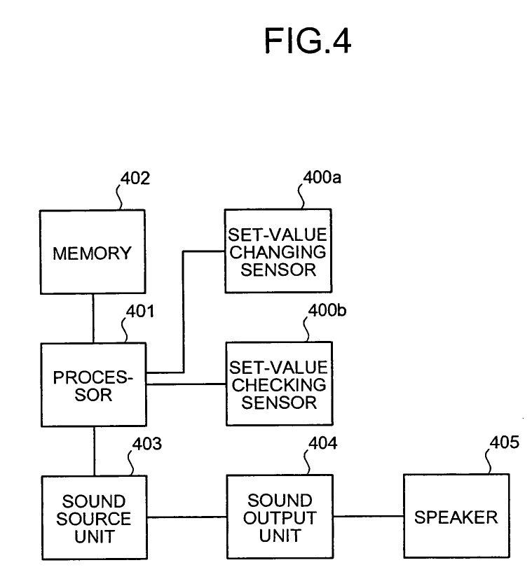

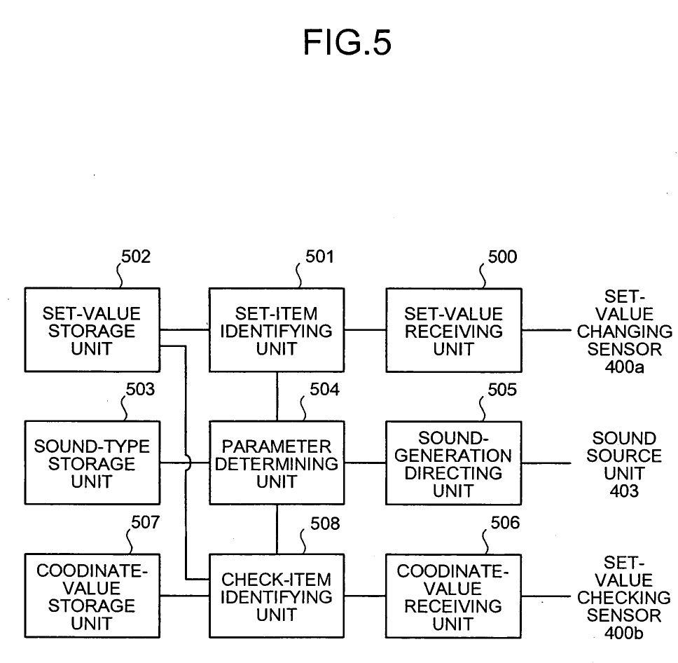

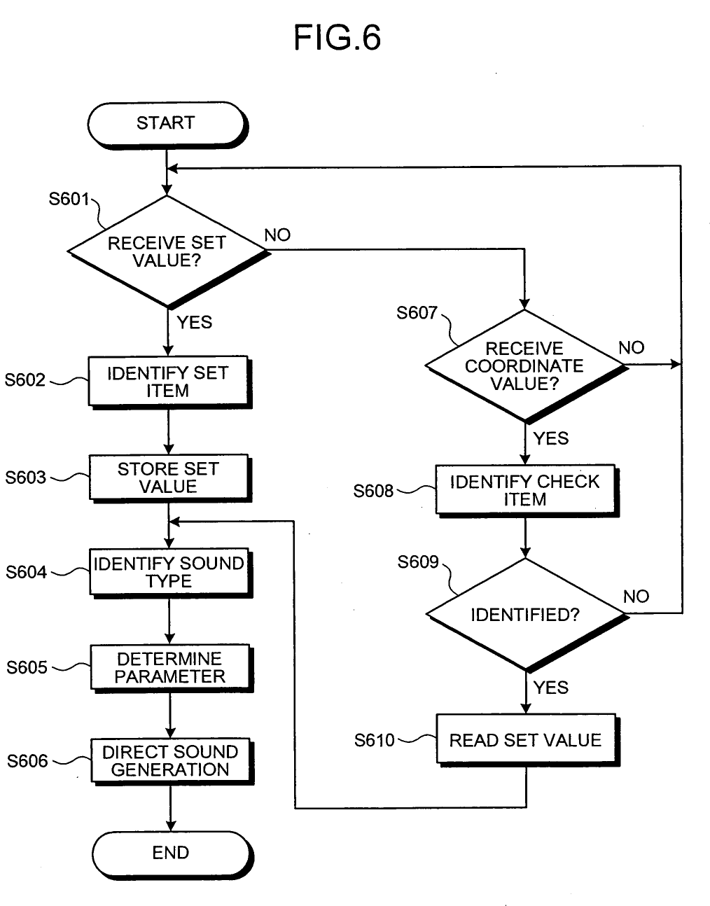

FIG. 4 is a block diagram of one example of the hardware configuration of the sound-data output device according to the second embodiment of the present invention. The difference from the example of the first embodiment is that the example of the second embodiment includes two kinds of sensors, a set-value changing sensor 400a that changes the current set value and a set-value checking sensor 400b that solely checks the current set value. The units other than the sensors 400a and 400b shown in FIG. 4 are the same as the units with the same names shown in FIG. 1.

The set-value changing sensor 400a is the same as the sensor 100 shown in FIG. 1 and includes a rotary encoder described above, for example. The set-value checking sensor 400b is a device, such as a “Virtual Keyboard” of VKB Inc that is capable of detecting the position of the hands of a user with an infrared ray or a CMOS sensor (or a CCD sensor) and capable of inputting a coordinate corresponding to the position, to a processor 401 in the device.

A functional configuration of the sound-data output device according to the second embodiment of the present invention will then be explained. FIG. 5 is a block diagram of the functional configuration of the sound-data output device according to the second embodiment of the present invention.

The difference from the functional configuration of the first embodiment shown in FIG. 2 is that, in the second embodiment, three units are added to the functional configuration of the first embodiment. The three units are, a coordinate-value receiving unit 506 that receives a coordinate from the set-value checking sensor 400b, a coordinate-value storage unit 507 that holds a coordinate value (sensing point) to check the set values of the set items, and a check-item identifying unit 508 that searches the coordinate-value storage unit 507 with the coordinate value input from the coordinate-value receiving unit 506 and that identifies the set value of a set item the user is trying to check. Specifically, the coordinate-value receiving unit 506 and the check-item identifying unit 508 are realized by the processor 401 that executes programs in the memory 402 shown in FIG. 4, and the coordinate-value storage unit 507 is realized by the memory 402.

### Second Example

A second example of the sound-data output device according to the second embodiment of the present invention will be explained. FIG. 6 is an explanatory view of the second example of the sound-data output device according to the second embodiment of the present invention. A flowchart of a procedure of the sound-data output process in accordance with changes and checks of the values of the various set items by the sound-data output device according to the second embodiment of the present invention is shown in FIG. 6. Steps S601 to S606 shown in FIG. 6 is a sound-data output process during changing of a set value, and are the same as the steps S301 to S306 shown in FIG. 3.

The flow that continues to steps S604 to S606 through steps S607 to 610 is the sound-data output process during the checking of a set value added in the second embodiment. For example, when a user puts his or her hand to a certain position in a space and a coordinate value corresponding to the position is input from the set-value checking sensor 400b shown in FIG. 4, the coordinate-value receiving unit 506 realized by the processor 401 receives the coordinate value (step S601: NO, step S607: YES) and outputs the received coordinate value to the check-item identifying unit 508.

The check-item identifying unit 508 identifies a check item by searching the coordinate-value storage unit 507 with the coordinate value input from the coordinate-value receiving unit 506 (step S608). When the coordinate value is close to a coordinate value (sensing point) corresponding to any of the set items, in other words, when the check-item identifying unit 508 identifies a set item to be checked (step S609: YES), the check-item identifying unit 508 reads a current set value of the item from the set-value storage unit 502 (step S610).

The check-item identifying unit 508 outputs a combination of the identified set item and the current set value to a parameter determining unit 504, and the parameter determining unit 504 that has received the combination searches the sound-type storage unit 503 and identifies a sound type corresponding to the item (step S604). The parameter determining unit 504 determines, based on the sound type and the set value, values of the various parameters characterizing the sound to be currently generated at a sound source unit 403 (step S605) The parameter determining unit 504 outputs the values to a sound-generation directing unit 505, and the sound-generation directing unit 505 generates a message to cause the sound source unit 403 to generate the sound and outputs the message to the sound source unit 403 (step S606).

While nothing is input from the set-value changing sensor 400a and the set-value checking sensor 400b (step S601: NO, step S607: NO), or when a set item to be checked cannot be identified, even though the coordinate value is input from the set-value checking sensor 400b (step S607: YES, step S608, step S609: NO), the process returns to step S601 and waits for a new input from the sensors 400a and 400b.

According to the second embodiment explained above, a sensing point to check the current set values of the set items is arranged at an arbitrary position in a space, and the user can output sounds corresponding to the current set values of the items by putting his or her hand to the position, etc. Therefore, the user can check the current set values just by listening without actually changing the set values or checking the set values by looking.

The sensing point and the location of sound output when touching the sensing point do not have to be at the same place. For example, when a driver as a user touches the sensing point arranged right in front of the user, a sound of a pitch proportional to the current value of the set item X corresponding to the position of the sensing point may be heard from overhead to the right of the user. However, matching the location and the sensing point is usually more user-friendly, at least for set items with constant location that are not changed by the set values. In the example above, the sensing point of the set item X is arranged overhead to the right, and the sound corresponding to the current value of X can be heard from just around where the hand of the user is raised.

According to the embodiments of the present invention explained above, the device receives a set value input by a user and identifies which set items the received set value corresponds to. The device then determines, based on at least one of the received set value and the set items identified by the identifying unit, a parameter characterizing a sound to become sound data in accordance with operation by the user, and outputs the sound characterized by the determined parameter. This enables the user to recognize, by listening, the continuous changes in values of the set items in accordance with the operations by the user as continuous changes in sounds.

The device reads a set value of a set item designated by the user and determines a parameter characterizing the sound, based on at least one of the read set value and the set item designated by the user. As a result, the user can recognize a current value of a target set item by listening.

As for the location of the sound generated in accordance with a change or a check of the set value, among the parameters, location of the sounds may be determined based only on the set item. Among the parameters, the location of the sounds may also be determined based on the set value and the set item.

The sound-data output method explained in the embodiments can be realized by executing a prepared program by a calculation processing device such as a processor and a microcomputer. The program is recorded in a recording medium readable by the calculation processing device such as a ROM, an HD, an FD, a CD-ROM, a CD-R, a CD-RW, an MO, and a DVD, and is executed by the calculation processing device by being read from the recording medium. The program may be a transmission medium distributable via a network such as the Internet.

1-6. (canceled)

7. A sound-data output device that outputs sound data as a sound in accordance with an operation by a user, the sound-data output device comprising:
a receiving unit that receives a set value from the user, wherein the set value is a continuously variable value changing in accordance with the operation by the user;
an identifying unit that identifies which set item the set value corresponds to;
a determining unit that determines, for at least one of each set value and each set item, parameters characterizing the sound different from one another based on the set value and the set item; and
an output unit that outputs a sound characterized by the parameters.

8. The sound-data output device according to claim 7, further comprising a reading unit that reads a set value of a set item designated by the user, wherein the determining unit determines, based on at least one of the set value read by the reading unit and the set item designated by the user, the parameters characterizing the sound.

9. The sound-data output device according to claim 7, wherein the determining unit determines, among the parameters, a location of the sound based on the set item.

10. The sound-data output device according to claim 7, wherein the determining unit determines, among the parameters, a location of the sound based on the set value and the set item.

11. A sound-data output method of outputting sound data as a sound in accordance with an operation by a user, the sound-data output method comprising:
receiving a set value from the user, wherein the set value is a continuously variable value changing in accordance with the operation by the user;
identifying which set item the set value corresponds to;
determining, for at least one of each set value and each set item, parameters characterizing the sound different from one another based on the set value and the set item; and
outputting a sound characterized by the parameters.

12. A computer-readable recording medium that stores therein a sound-data output program for outputting sound data as a sound in compliance with an operation by a user, the sound-data output program causing a computer to execute:
receiving a set value from the user, wherein the set value is a continuously variable value changing in accordance with the operation by the user;
identifying which set item the set value corresponds to;
determining, for at least one of each set value and each set item, parameters characterizing the sound different from one another based on the set value and the set item; and
outputting a sound characterized by the parameters.
